(19) United States
(12) Patent Application Publication
(10) Pub. No.: US 2026/0014687 A1
(43) Pub. Date: Jan. 15, 2026

(54) POWERED FASTENER DRIVER

(71) Applicant: Techtronic Cordless GP, Anderson, SC (US)

(72) Inventor: Joseph Manuel Suarez, Anderson, SC (US)

(21) Appl. No.: 19/337,031

(22) Filed: Sep. 23, 2025

Related U.S. Application Data
(63) Continuation of application No. 18/326,757, filed on May 31, 2023, now Pat. No. 12,420,396.
(60) Provisional application No. 63/347,923, filed on Jun. 1, 2022.

(51) Int. Cl. B25C 7/00; B25C 1/04; B25C 1/06; F21V 23/04; F21V 33/00

(52) U.S. Cl. CPC B25C 7/00; B25C 1/047; B25C 1/06; F21V 23/0442; F21V 33/008

(57) ABSTRACT

A powered fastener driver includes a driver blade, a lifter, a nose piece, a magazine, and a light. The driver blade is configured to be movable between a top-dead center position and a bottom-dead center position. The lifter is operable to move the driver blade from the bottom-dead center position toward the top-dead center position. The drier blade is extendable through the nose piece when moving from the top-dead center position to the bottom-dead center position. The magazine is configured to transfer individual fasteners into the nose piece. The magazine has a front side configured to face the workpiece during driving of the fastener, an opposite rear side, and a lateral side extending between the front side and the rear side. The light is positioned adjacent the lateral side of the magazine closer to the front side than the rear side.

### CROSS-REFERENCE TO RELATED APPLICATIONS

This application is a continuation of U.S. Non-Provisional patent application Ser. No. 18/326,757, filed May 31, 2023, which claims to the benefit of U.S. Provisional Patent Application No. 63/347,923 filed on Jun. 1, 2022, the entire contents of which are incorporated by reference herein.

### FIELD OF THE DISCLOSURE

The present disclosure relates to powered fastener drivers, and more specifically to lights for use with powered fastener drivers.

### BACKGROUND OF THE DISCLOSURE

There are various fastener drivers known in the art for driving fasteners (e.g., nails, tacks, staples, etc.) into a workpiece. Occasionally, fastener drivers are used in confined spaces or other conditions where light is limited. It may be desirable for a user to see a nose piece of the fastener driver and the workpiece. Better illumination at the nose piece of the fastener driver greatly improves the ability to position a fastener with pinpoint accuracy. Known fastener driver lights can cast shadows that obstruct visibility of the nose piece over the work surface. Thus, a user has decreased ability to see where on the work surface the fastener will be inserted.

### SUMMARY OF THE DISCLOSURE

The present disclosure provides, in one aspect, a powered fastener driver. The powered fastener driver may include a driver blade, a lifter, a nose piece, a magazine, and a light. The driver blade is configured to be movable between a top-dead center position and a bottom-dead center position. The lifter is operable to move the driver blade from the bottom-dead center position toward the top-dead center position. The driver blade is extendable through the nose piece when moving from top-dead center to the bottom-dead center position. The magazine is configured to transfer individual fasteners into the nose piece, the magazine having a front side configured to face the workpiece during driving of the fastener, a rear side opposite the front side, and a lateral side. The light is positioned adjacent the lateral side of the magazine closer to the front side than the rear side.

The present disclosure provides, in another aspect, a powered fastener driver. The powered fastener driver may include a driver blade, a lifter, a nose piece, a magazine, and a light. The driver blade is configured to be movable between a top-dead center position and a bottom-dead center position. The lifter is operable to move the driver blade from the bottom-dead center portion toward the top-dead center position. The driver blade is extendable through the nose piece when moving from the top-dead center position to the bottom-dead center position. The magazine is configured to pass the fastener into alignment with the driver blade. The magazine has a front side configured to face the workpiece during driving of the fastener, an opposite rear side, and a lateral side extending between the front side and the rear side. The light is positioned adjacent the lateral side and the front side of the magazine. The light is configured to direct light toward the nose piece and the workpiece.

The present disclosure provides, in another aspect, a powered fastener driver. The powered fastener driver may include a driver blade, a lifter, a nose piece, a magazine, a sensor, a controller, and a light. The driver blade is configured to be movable between a top-dead center position and a bottom-dead center position. The lifter is operable to move the driver blade from the bottom-dead center position toward the top-dead center position. The driver blade is extendable through the nose piece when moving from the top-dead center position to the bottom-dead center position. The magazine is configured to transfer individual fasteners into the nose piece. The magazine has a front side configured to face the workpiece during driving of the fastener, an opposite rear side, and a lateral side extending between the front side and the rear side. The controller is configured to receive a signal from the sensor in response to an event. The light is coupled to the controller and is configured to direct light toward the nose piece and the workpiece. The light is operable by the controller to be actuated in a pattern in response to the event. The light is positioned adjacent the lateral side of the magazine.

Other features and aspects of the disclosure will become apparent by consideration of the following detailed description and accompanying drawings.

### BRIEF DESCRIPTION OF THE DRAWINGS

FIG. 1 is a perspective view of a gas spring-powered fastener driver.

FIG. 2 is a perspective view of the gas spring-powered fastener driver of FIG. 1 with a portion of a housing removed.

FIG. 3 is a side view of the gas spring-powered fastener driver of FIG. 1.

FIG. 4 is a side view of the gas spring-powered fastener driver of FIG. 1 with a portion of the housing removed.

FIG. 5 is a cross-sectional view of a portion of the gas spring-powered fastener driver of FIG. 1.

FIG. 6 is a perspective view of a main pusher of the gas spring-powered fastener driver of FIG. 1.

FIG. 7 is a schematic view of the gas spring-powered fastener driver of FIG. 1.

FIG. 8 is a perspective view of another gas spring-powered fastener driver.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

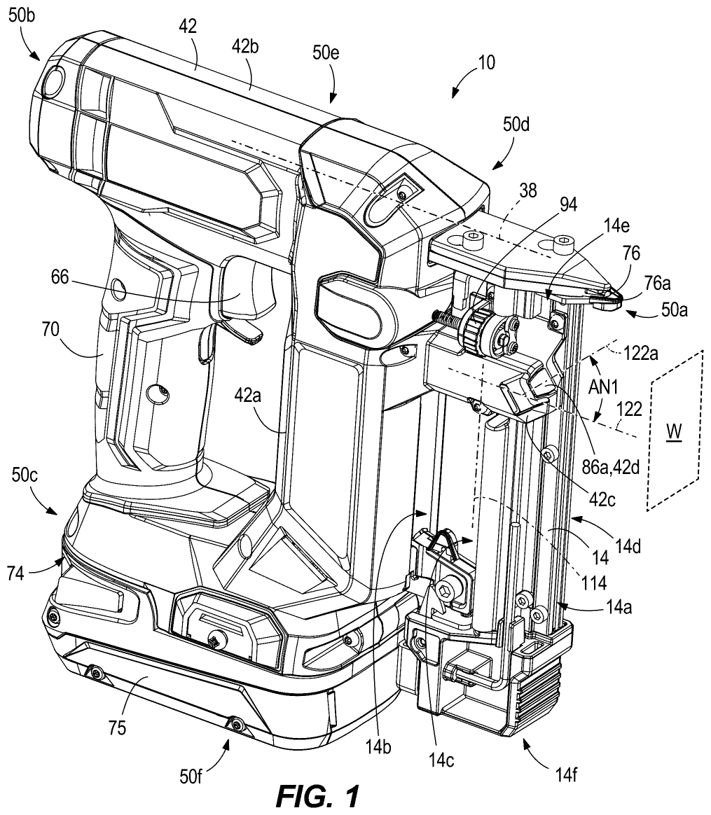

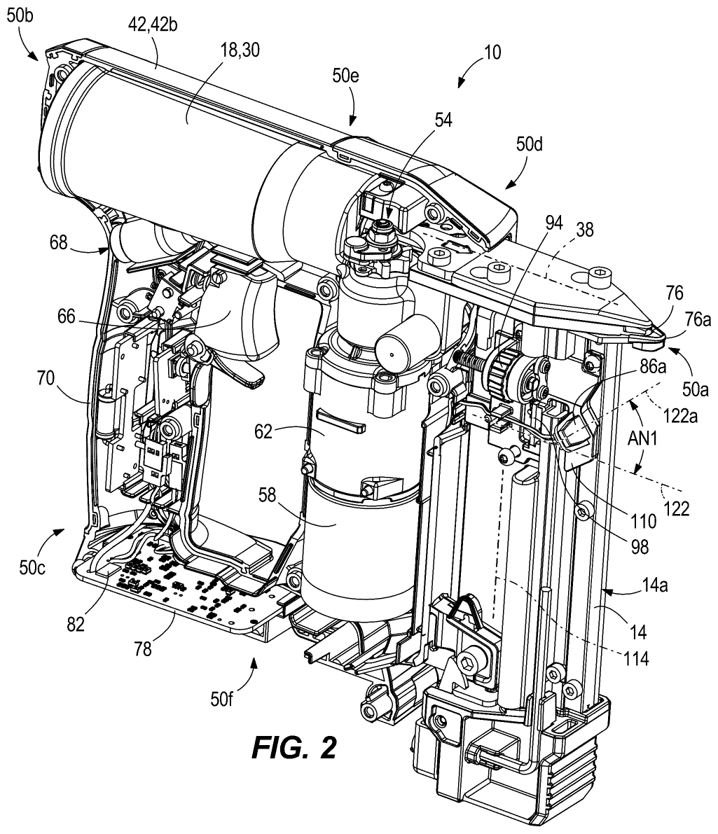

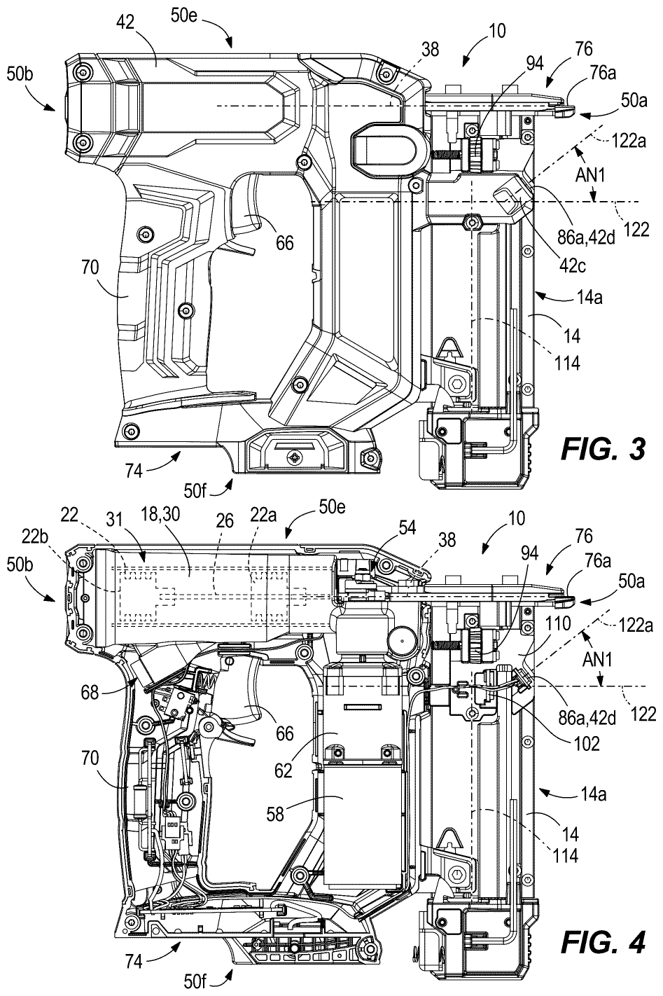

With reference to FIGS. 1-4, a gas spring-powered fastener driver 10 is operable to drive (e.g., nails, tacks, staples, etc.) held within a magazine 14 into a workpiece W. FIG. 2 illustrates some of the internal components of the fastener driver 10. The fastener driver 10 may include a piston cylinder 18 and a moveable drive piston 22 (FIG. 4) positioned within the piston cylinder 18 (FIG. 2). The fastener driver 10 may further include a driver blade 26 that is attached to the piston 22 and moveable therewith. The fastener driver 10 may include an outer storage chamber cylinder 30 of pressurized gas in communication with the piston cylinder 18. The outer storage chamber cylinder 30 defines a storage chamber 31 (FIG. 4) in which compressed gas is stored. The storage chamber 31 is in fluid communication with the piston cylinder 18. In the illustrated embodiment, the storage chamber cylinder 30 is coaxial with the piston cylinder 18, the piston 22, and the driver blade 26 along a driving axis 38. The piston 22 and thus the driver blade 26 are movable along the driving axis 38 between a bottom-dead-center (i.e., BDC) position (illustrated with piston 22a, FIG. 4) and a top-dead-center (i.e., TDC) position (illustrated with piston 22b, FIG. 4).

The illustrated fastener driver 10 may be a gas-spring powered fastener driver 10. Other similar pneumatic or otherwise powered fastener drivers 10 are possible. The gas spring powered fastener driver 10 may include a housing 42 within which the outer storage chamber cylinder 30 may be positioned. FIG. 1 illustrates the housing 42. The housing includes a motor portion 42a, a piston cylinder portion 42b, and a compartment 42c. The compartment 42c extends from the motor portion 42a. The fastener driver 10 has a working side 50a (i.e., a front side) and an opposite distal side 50b (i.e., a rear side). The fastener driver 10 has a first lateral side 50c (i.e., a right side) and an opposite second lateral side 50d (i.e., a left side). The fastener driver 10 has a first vertical side 50e (i.e., a top side) and an opposite second vertical side 50f (i.e., a bottom side). In the illustrated embodiment, the above-described first lateral side 50c is a right side of the fastener driver 10, and the above-described second lateral side 50d is a left side of the fastener driver 10. In the illustrated embodiment, the above-described first vertical side 50e may be described as a top side of the fastener driver 10, and the second vertical side 50f may be described as a bottom side of the fastener driver 10.

The magazine 14 also includes a working side 14a (i.e., front side) closest to the working side 50a of the fastener driver 10 and an opposite distal side 14b (i.e., rear side) closest to the distal side 50b of the fastener driver 10. Accordingly, during use (e.g., driving of fastener[s]) of the fastener driver 10, the working side 14a (i.e., front side) of the magazine 14 may face at least the nose piece 76. In typical operation, the working side 14a (i.e., front side) of the magazine 14 will also face the work contact tip 76a and the workpiece W. However, other embodiments not including the work contact tip 76a are possible, and the geometry and dimensions workpiece W may differ. The working side 14a may be referred to as a front side of the magazine 14. The magazine 14 also includes a first lateral side 14c (i.e., a right side) and an opposite second lateral side 14d (i.e., a left side). The first lateral side 14c (i.e., the right side) of the magazine 14 is positioned adjacent to the first lateral side 50c (i.e., the right side) of the fastener driver 10. The second lateral side 14d (i.e., the left side) of the magazine 14 is positioned adjacent to the second lateral side 50d (i.e., the left side) of the fastener driver 10. The magazine 14 also includes a first end 14e (i.e., a top side) proximal to a lifting assembly 54 and an opposite second end 14f (i.e., a bottom side) adjacent the second vertical side 50f (i.e., the bottom side) of the fastener driver 10. The sides of the fastener driver 10 and magazine 14 are described in a single orientation relative to the workpiece W—with the working (i.e., front) sides thereof 50a, 14a facing the workpiece W. However, the fastener driver 10 and magazine 14 may be oriented in various orientations during normal use of the fastener driver 10.

With reference to FIG. 2, the piston cylinder 18 and the driver blade 26 define a driving axis 38. The piston cylinder 18 is positioned within the piston cylinder portion 42b of the housing 42. During a driving cycle, the driver blade 26 and the piston 22 may be movable between the top-dead-center (i.e., TDC) position (piston 22b, FIG. 4) and a driven or bottom-dead-center (BDC) position (piston 22a, FIG. 4). The fastener driver 10 further includes the above-mentioned lifting assembly 54 (FIGS. 2, 4), which is powered by a motor 58, and which is operable to move the driver blade 26 from the driven position to the TDC position (piston 22b, FIG. 4). As illustrated in the illustrated embodiment of FIG. 4, a gearbox 62 may be positioned between the motor 58 and the lifting assembly 54. In other embodiments, the gearbox 62 can be circumvented, with the motor 58 being directly coupled to the lifting assembly 54. The motor 58 is positioned within the motor portion 42a of the housing 42.

In operation, the lifting assembly 54 may drive the piston 22 and the driver blade 26 toward the TDC position by energizing the motor 58. As the piston 22 and the driver blade 26 are driven toward the TDC position, the gas above the piston 22 and the gas within the storage chamber cylinder 30 may be compressed. Prior to reaching the TDC position, the motor 58 may be deactivated and the piston 22 and the driver blade 26 are held in a ready position, which is located between the TDC and the BDC or driven positions, until being released by user activation of a trigger 66 (FIG. 1). When released, the compressed gas above the piston 22 and within the storage chamber cylinder 30 may drive the piston 22 and the driver blade 26 to the driven position, thereby driving a fastener into the workpiece. The illustrated fastener driver 10 therefore operates on a gas spring principle utilizing the lifting assembly 54 and the piston 22 to further compress the gas within the piston cylinder 18 and the storage chamber cylinder 30. While being driven, the driver blade 26 is extendable through a nose piece 76 when moving from top-dead center to the bottom-dead center position. After a fastener is ejected from the nose piece 76, the magazine 14 transfers another individual fastener into the nose piece 76. Further detail regarding the structure and operation of the fastener driver 10 is provided below. The fastener driver 10 of FIG. 2 may include a fill port 68 configured to receive external gas and pass external gas into the storage chamber cylinder 30 (and thereby, the storage chamber 31).

With continued reference to FIG. 2, the piston cylinder 18 and the outer storage chamber cylinder 30 may both extend generally along the driving axis 38. Adjacent the distal side 50b, the housing 42 may include a handle 70 extending generally perpendicularly from the working axis 38 between the first vertical side 50e and the second vertical side 50f. A battery receptacle 74 may be provided at a distal side of the handle 70 positioned furthest from a work contact tip 76a of a nose piece 76-the work contact tip 76a contacting the workpiece W. The battery receptacle 74 may be configured to receive a battery pack 75 (FIG. 1) therein for coupling the battery pack 75 to the motor 58. The battery pack 75 may also be coupled to a tool printed circuit board 78. The tool printed circuit board 78 has an on-board controller 82. In other embodiments, the fastener driver 10 may be a corded power tool and the battery receptacle 74 may be omitted.

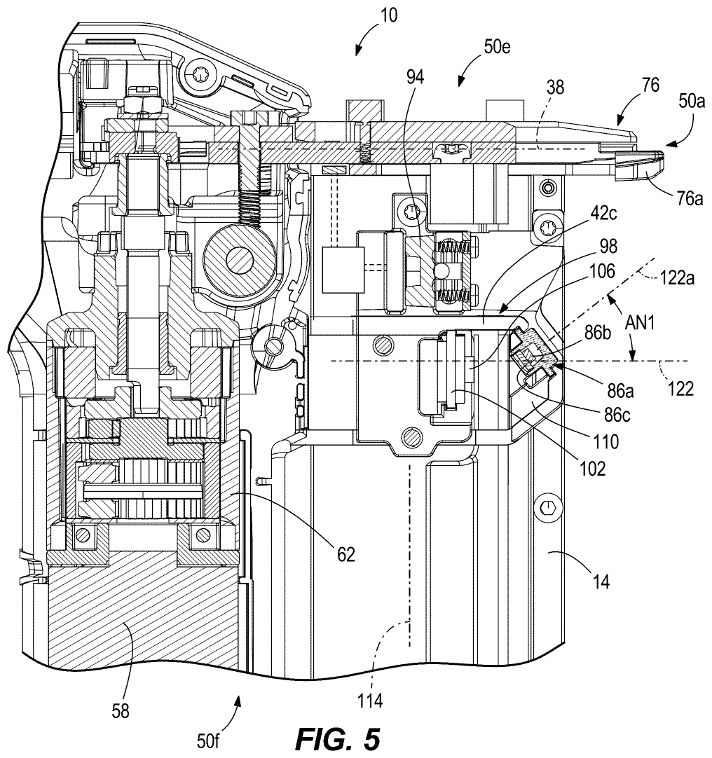

The controller 82 may be configured to operate (e.g., actuate, selectively dim, turn ON and OFF) a light 86a. In some embodiments (e.g., FIG. 5), the light 86a may include one or more light emitting diodes (LEDs) 86b or other light emitting elements 86b mounted on a printed circuit board 86c. In other embodiments, the light 86a may include one or more light emitting diodes (LED) 86b or other light emitting element 86b wired to a power source without a printed circuit board 86c. The light 86a may be adjacent to a light transparent window 42d of the housing 42 such that the light transparent window 42d shields the light 86a from debris external to the fastener driver 10 while permitting passage of light emitted by the light emitting element 86b therethrough. The transparent window 42d may allow rays of light emitted by the light emitting element 86b to pass therethrough without further direction by the transparent window 42d. Alternatively, the transparent window 42d may function as a lens to further direct rays of light emitted by the light emitting element 86b towards the nose piece 76 and the workpiece W. The light 86a may be positioned on the first lateral side 14c of the magazine 14 closer to the working side 14a than the distal side 14b of the magazine 14. More specifically, the light 86a may be positioned on the first lateral side 14c of the magazine 14 adjacent the working side 14a. In the illustrated embodiment, the light 86a is positioned at the working side 14a of the magazine 14. Accordingly, rays of light emitted when the light 86a emits light extend along the driving axis in a direction extending from the distal side 50b and beyond the working side 50a. In the illustrated embodiment, a lens 90 (FIG. 1) may cover at least a portion of the light 86a. The lens 90 may be a total internal reflection (TIR) lens. Other types of lenses are possible. The lens 90 may direct rays of light emitted by the light 86a towards the nose piece 76 and the workpiece W. The lens 90 may be positioned within the light transparent window 42d of the housing 42 such that the lens 90 is shielded from debris by the light transparent window 42d.

With continued reference to FIGS. 1 and 2, the powered fastener driver 10 may further include a depth of drive (e.g., DOD) assembly 94. The depth of drive assembly 94 may be configured to receive user input (e.g., rotation) such that a user may adjust a depth of driving of a fastener into the workpiece W dependent on working conditions (e.g., the type of fastener, the density of the workpiece W). The depth of drive assembly 94 may be positioned closer to the first vertical side 50e when compared to the light 86. The depth of drive assembly 94 may be positioned on the magazine 14. More specifically, the depth of drive assembly 94 may be user-operable from the same lateral side (e.g., the first lateral side 50c) of the fastener driver 10 when compared to the light 86. Other arrangements are possible.

With reference to FIGS. 1 and 2, the fastener driver 10 may further includes a dry fire lockout mechanism 98. The dry fire lockout mechanism 98 is positioned within the compartment 42c adjacent the first lateral side (i.e., the right side) of the magazine 14. The compartment 42c is positioned laterally outboard of the magazine 14. In other embodiments, the compartment 42c and thus the dry fire lockout mechanism 98 may be positioned adjacent the second lateral side (i.e., the left side) of the magazine 14. The illustrated dry fire lockout mechanism 98 (FIG. 2) may include a dry fire printed circuit board 102 and a hall effect sensor 106. Other types of sensors may function adequately to perform the duties of the dry fire lockout mechanism 98. The hall effect sensor 106 may be mounted upon the dry fire printed circuit board 102. The dry fire printed circuit board 102 and thus the hall effect sensor 106 are electrically coupled to the controller 82. The hall effect sensor 106 may be configured to generate a signal and report the signal to the controller 82 in response to a main pusher 110 of the magazine 14 reaching a position corresponding to an empty state of the magazine 14 in which no fasteners are positioned within the magazine. The main pusher 110 may be magnetic and/or include a magnet mounted thereto. As illustrated in FIG. 5, the main pusher 110 is movable along a magazine axis 114. The main pusher 110 feeds fasteners into alignment with the driver blade 26 for driving the fastener into the workpiece W. The magazine axis 114 is generally perpendicular to the driving axis 38.

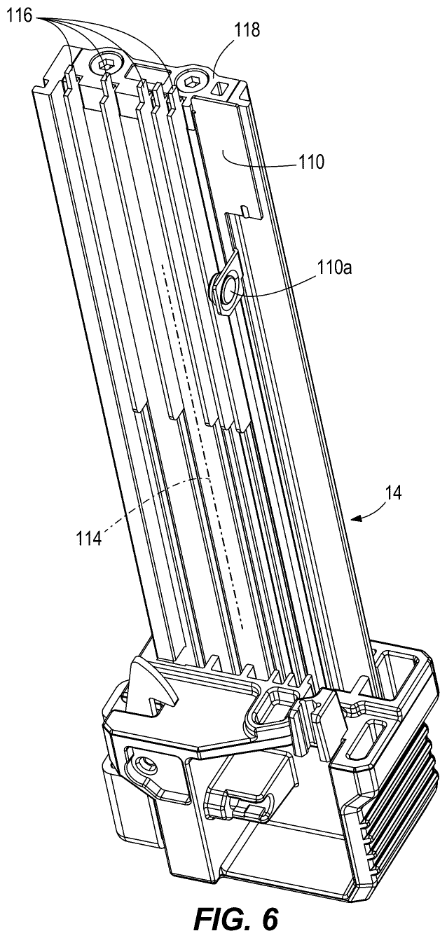

The main pusher 110 is more clearly illustrated in FIG. 6. The main pusher 110 may include a magnet 110a which operates along with the hall effect sensor 106 to generate the signal indicative of the empty state of the magazine 14. A plurality of small pushers 116 may operate along with the main pusher 110 to push the fasteners into alignment with the driver blade 26, and thus the lifting assembly 54. The fasteners may be biased into alignment with the driver blade 26 by a spring 118. The spring 118 may press against the magazine 14.

Returning to the embodiment illustrated in FIG. 5, the dry fire lockout mechanism 98 may be aligned with the light 86a along a light axis 122. The compartment 42c extends parallel to the light axis 122. The light axis 122 extends in a direction generally parallel to the driving axis 38 and between the working side 50a and the distal side 50b. In other words, the dry fire lockout mechanism 98 is provided at the same height as the light 86. The dry fire lockout mechanism 98 is provided closer to the distal side 50b when compared to the light 86. The dry fire lockout mechanism 98 is provided on the same lateral side (e.g., the right side) of the fastener driver 10 as the light 86.

The light 86a is positioned at least partially in the compartment 42c adjacent the first lateral side (i.e., the right side) of the magazine 14. As mentioned above, the compartment 42c may be adjacent the second lateral side (i.e., the left side) of the magazine 14. The light 86a is capable of emitting light in a direction forward of the compartment 42c (i.e., through the transparent aforementioned light transparent window 42d). In a front-rear direction, the light 86a may be positioned closer to the working side 14a (i.e., front side) of the magazine 14 than the distal side 14b (i.e., rear side) of the magazine 14. In some embodiments, the light 86a may be positioned at least partially in-line with the working side 14a (i.e., front side) of the magazine 14. In other embodiments, the light 86a may be positioned between the working side 14a (i.e., front side) and the distal side 14b (i.e., rear side). As such, rays of light emitted by the light 86a reduce the size and amount of shadow(s) cast at an interface of where the fastener will enter the workpiece W as the fastener exits the nose piece 76. The aforementioned position of the light 86a is directly related to minimizing obstructions between the light 86a and a point at which the fastener will exit the nose piece 76.

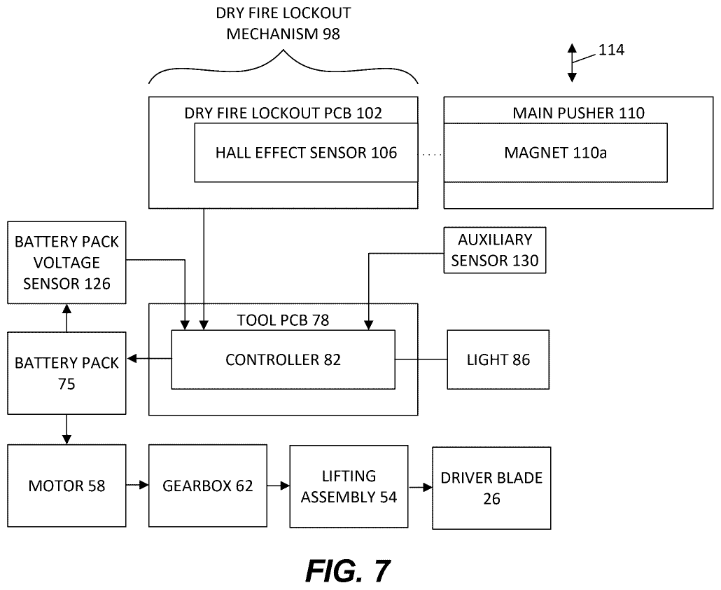

With reference to FIG. 7, the controller 82 may be configured to actuate the light in response to input from the dry fire lockout mechanism 98, a battery pack voltage sensor 126, and/or an auxiliary sensor 130. The dry fire lockout mechanism 98 may send a signal to the controller 82 upon detecting that no fasteners remain in the magazine 14. The battery pack voltage sensor 126 may send a signal to the controller 82 upon detection that the battery pack 75 is operating at a non-ideal voltage below a threshold voltage of the battery pack 75. The auxiliary sensor 130 may be any other sensor configured to monitor operation of the various components of the powered fastener driver 10 (e.g., the motor 58, the gearbox 62, pressure within the outer storage chamber cylinder 30 and/or the storage chamber 31, etc.). The auxiliary sensor 130 may send a signal to the controller 82 upon detection that the powered fastener driver 10 is not operating correctly (e.g., generic tool operation error, jam of a fastener, gears of the gearbox 62 being out of sync, etc.).

The controller 82, in turn, may actuate (e.g., turn ON and OFF) the light 86a based on the input from the dry fire lockout mechanism 98, the battery pack voltage sensor 126, and/or the auxiliary sensor 130. In the illustrated embodiment, the controller 82 may cycle the light 86a between an ON condition in which the light 86a emits rays of light and an OFF condition in which the light does not emit rays of light. In the ON condition, the rays of light shine upon the at least one of the nose piece 76 and the workpiece W. In the illustrated embodiment, a time that the light is on (e.g., ON TIME 134) and a time that the light is off (e.g., OFF TIME 138) are similar in response to each of the inputs from the dry fire lockout mechanism 98, the battery pack voltage sensor 126, and/or the auxiliary sensor 130. However, other arrangements in which the ON TIME 134 and the OFF TIME 138 are different are possible.

As illustrated in the Table below, the controller 82 may actuate the light 86a based on a variety of codes C1-C3. In other words, the controller 82 is programmed with a plurality of patterns for actuating the light 86a in response to any one of a plurality of events sensed by any of the dry fire lockout mechanism 98, the battery pack voltage sensor 126, and/or the auxiliary sensor 130. When the dry fire lockout mechanism 98 sends the signal to the controller 82, a code C3 is followed. The controller 82 receives the code C3 and actuates the light a blink count number BC3 in accordance with the code. The exemplary blink count BC3 is four. Blink count BC3 represents four cycles of the light 86a between the ON condition and the OFF condition. While cycling through the ON condition and the OFF condition, the ON TIME 134 and OFF TIME 138 of the code C3 are followed. In the illustrated embodiment, the ON TIME 134 and the OFF TIME 138 are each 200 milliseconds (ms). Other timings are possible. The battery pack voltage sensor 126, and/or the auxiliary sensor 130 operate along the same principles, but having differing blink counts (BC1-BC2) as well as different ON TIMEs 134 and OFF TIMEs 138 as enumerated in the Table below. The actual ON TIME 134 and OFF TIME 138 may be ±5% of the stated ON TIME 134 and OFF TIME 138 to allow for error in clock timing of the controller 82. Other amounts of clock timing error may are envisioned.

TABLE

| Code | Blink Count | | ON TIME 134 | | OFF TIME 138 | |
|---|---|---|---|---|---|---|
| Protective | 120 | (BC1) | 1,000 | ms | 1,000 | ms |
| Lockout (C1) | | | | | | |
| Low Battery | ≈19-20 | (BC2) | 500 | ms | 500 | ms |
| Voltage (C2) | | | | | | |
| Dry Fire | 4 | (BC3) | 200 | ms | 200 | ms |
| Lockout (C3) | | | | | | |

The aforementioned examples relating to actuation of the light 86a relate to instances (i.e., codes C1-C2) where the controller 82 may cause the fastener driver 10 not to cycle (e.g., fire) upon activation of the trigger 66. In other words, the aforementioned examples relate to actuation of the light 86a where the controller 82 inhibits driving of the driver blade 26 from its top-dead center position toward its bottom-dead center position. However, the controller 82 may actuate (e.g., turn ON and OFF) the light 86a based on any instance (i.e., code) in which the fastener driver 10 is still capable of cycling (e.g., firing) upon activation of the trigger 66. For example, other instances (i.e., codes) may include but are not limited to the fastener driver 10 being in an increased power level mode, a reduced power level mode, and the like. In the increased power level mode, for example, pressure within the storage chamber 31 may be above a desired pressure but less than an unsafe pressure. Instances other than raised pressure may also cause the fastener driver 10 to be placed in the increased power level mode. In the decreased power level mode, for example, pressure within the storage chamber 31 may be below a desired pressure but greater than an unusable pressure (at which fasteners may not enter the workpiece W to a desired depth). Instances other than lowered pressure may also cause the fastener driver 10 to be placed in the reduced power level mode. As such, the light 86a may notify the user about the mode in which the tool will operate by the flashes that the light 86a provides. In some instances, the actuation of the light 86a corresponding with when the fastener driver 10 is still capable of cycling (e.g., firing) may be initiated (e.g., started) upon activation of at least one or both of the nose piece 76 with the workpiece W and the trigger 66. In other instances, actuation of the light to indicate any instance (i.e., code) in which the fastener driver 10 is still capable of cycling (e.g., firing) may be initiated when the instance (e.g., raised or lowered pressure in the storage chamber 31) is sensed (e.g., by the auxiliary sensor 130). The light 86a may also be operated in modes corresponding with different types of usable but undesired values such as, without limitation, usable but not desired voltage supplied by the battery pack 75.

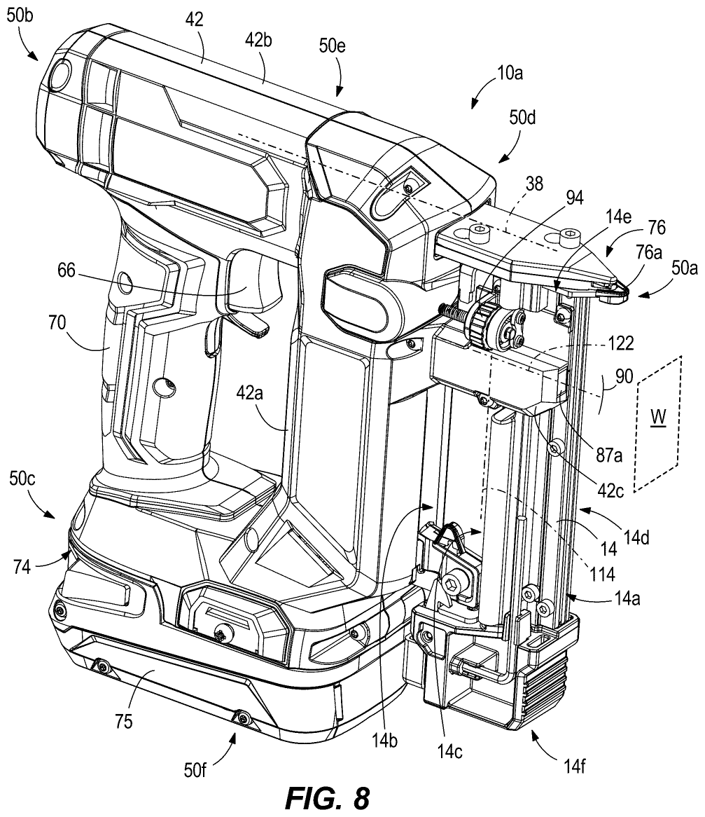

FIGS. 1-5 illustrate a fastener driver 10 with a light 86a mounted at least partially in the compartment 42c and adjacent the magazine 14 with the light 86a oriented to project light along an auxiliary light axis 122a in a direction towards the nose piece 76 and workpiece W. The auxiliary light axis 122a is transverse to the above-described light axis 122. The auxiliary light axis 122a permits the light 86a to directly shine upon the nose piece 76 and the workpiece W without requiring a lens 90, such as the lens 90 described above in the fastener driver 10. However, a lens 90 may be applied to the light 86a to further redirect the rays emitted by the light 86a. The auxiliary light axis 122a may be angled relative to the above-described light axis 122 an angle AN1 (FIG. 5). The angle AN1 is measured between the auxiliary light axis 122a and the light axis 122 in a plane parallel to an intersecting plane of the driving axis 38 and the magazine axis 114. In the illustrated embodiment, the angle AN1 is approximately 37 degrees. In other embodiments, the angle AN1 may be greater than 0 degrees and less than 90 degrees. In other embodiments, the angle AN1 may be equal to or greater than 30 degrees and equal to or less than 60 degrees. The angle AN1 may be equal to or greater than 30 degrees and equal to or less than 45 degrees. As illustrated in FIG. 8, alternate fastener drivers 10a similar to the fastener driver 10 may include lights 87a positioned at least partially within the compartment 42c, adjacent to the magazine 14, and oriented generally parallel to the light axis 122 (i.e., the angle AN1 may be approximately 0 degrees in some embodiments). One or both of the aforementioned lens 90 or the light transparent window 42d may be configured to direct light emitted by the light 87a towards the nose piece 76 (e.g., adjacent the work contact tip 76a) and the workpiece W.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A powered fastener driver configured to drive a fastener into a workpiece, the powered fastener driver comprising:
a driver blade configured to be movable between a top-dead center position and a bottom-dead center position;
a lifter operable to move the driver blade from the bottom-dead center position toward the top-dead center position;
a nose piece through which the driver blade is extendable when moving from the top-dead center position to the bottom-dead center position;
a magazine configured to transfer fasteners into the nose piece, the magazine having a front side configured to face the workpiece during driving of the fastener, an opposite rear side, and a lateral side extending between the front side and the rear side;
a sensor;
a controller configured to receive a signal from the sensor in response to an event; and
a light coupled to the controller and configured to direct light toward the nose piece and the workpiece, the light being operable by the controller to be actuated in a pattern in response to the event, the light being positioned adjacent the lateral side of the magazine between the front side and the rear side;
wherein the actuation of the light is visible at the nose piece to indicate the event.

2. The powered fastener driver of claim 1, further comprising a motor, wherein the sensor is a motor sensor configured to monitor operation of the motor, and wherein the pattern is indicative of a motor error.

3. The powered fastener driver of claim 2, wherein the motor sensor is configured to monitor operation of the motor to indicate jam of a fastener, and wherein the pattern is indicative of the jam.

4. The powered fastener driver of claim 1, further comprising a gearbox, wherein the sensor is a gearbox sensor configured to monitor operation of the gearbox, and wherein the pattern is indicative of gears of the gearbox being out of sync.

5. The powered fastener driver of claim 1, wherein the powered fastener driver is a gas spring powered fastener driver including a piston coupled to the driver blade and movable within a piston cylinder, the powered fastener driver further comprising a storage chamber in which compressed gas is stored, the storage chamber being in fluid communication with the piston cylinder, wherein the sensor comprises a pressure sensor which monitors for raised or lowered pressure in the storage chamber, the pattern being indicative of the raised pressure or the lowered pressure.

6. The powered fastener driver of claim 1, wherein the sensor comprises a dry fire lockout mechanism which monitors for an empty state of a magazine in which no fasteners are positioned within the magazine, and wherein the pattern is indicative of the empty state of the magazine.

7. The powered fastener driver of claim 1, further comprising a battery pack in electrical communication with the controller, wherein the sensor comprises a battery pack voltage sensor which monitors for non-ideal voltage below a threshold voltage of the battery pack, the pattern being indicative of the non-ideal voltage.

8. A powered fastener driver configured to drive a fastener into a workpiece, the powered fastener driver comprising:
a driver blade configured to be movable between a top-dead center position and a bottom-dead center position;
a lifting assembly operable to move the driver blade the bottom-dead center position toward the top-dead center position;
a nose piece through which the driver blade is extendable when moving from the top-dead center position to the bottom-dead center position;
a magazine configured to transfer fasteners into the nose piece, the magazine having a front side configured to face the workpiece during driving of the fastener, an opposite rear side, and a lateral side extending between the front side and the rear side;
a sensor monitoring operation of the lifting assembly and configured to generate a signal indicative of an error related to the lifting assembly;
a controller receiving the signal and detecting a first type of error related to the lifting assembly and detecting a second type of error related to the lifting assembly; and
a light coupled to the controller and actuatable in a first pattern in response to detecting the first type of error, and actuatable in a second pattern in response to detecting the second type of error.

9. The powered fastener driver of claim 8, wherein the sensor is configured to monitor operation of the lifting assembly to indicate a fastener jam, and wherein the pattern is indicative of the jam.

10. The powered fastener driver of claim 8, wherein the lifting assembly includes a motor and a gearbox coupled to the motor.

11. The powered fastener driver of claim 10, wherein the first type of error relates to a motor operation error.

12. The powered fastener driver of claim 10, wherein the second type of error relates to a gearbox syncing error.

13. The powered fastener driver of claim 8, further comprising a storage chamber cylinder of compressed gas configured to selectively move the driver blade in a direction from the top-dead center position toward the bottom-dead center position, and
an auxiliary sensor configured to monitor pressure of the storage chamber cylinder and configured to generate an auxiliary signal indicative of an error related to raised or lowered pressure of the storage chamber cylinder.

14. The powered fastener driver of claim 13, wherein the light is actuatable in a third pattern in response to detecting a third type of error indicative of the pressure of the storage chamber cylinder being an undesirable pressure.

15. A powered fastener driver configured to drive a fastener into a workpiece, the powered fastener driver comprising:
a piston movable within a piston cylinder, the piston cylinder in fluid communication with a storage chamber in which compressed gas is stored;
a driver blade coupled to the piston and configured to be movable between a top-dead center position and a bottom-dead center position;
a lifting assembly operable to move the driver blade the bottom-dead center position toward the top-dead center position;
a pressure sensor which monitors pressure in the storage chamber and configured to generate a signal indicative of the pressure in the storage chamber;
a controller configured to receive the signal from the pressure sensor and to determine whether the storage chamber pressure is an undesired pressure; and
a light coupled to the controller and operable by the controller upon receipt of the signal to be actuated in a pattern indicative of the undesired pressure.

16. The powered fastener driver of claim 15, wherein the light is configured to direct light toward the nose piece and the workpiece, wherein the actuation of the light is visible at the nose piece to indicate the undesired pressure.

17. The powered fastener driver of claim 15, wherein the undesired pressure corresponds with one of an increased power level, a reduced power level, or an unsafe power level.

18. The powered fastener driver of claim 17, wherein the light is actuatable in one of a plurality of patterns, wherein each of the patterns corresponds with one of the increased power level, the reduced power level, and the unsafe power level.

19. The powered fastener driver of claim 15, wherein the controller can determine that the storage chamber pressure is an unsafe pressure and inhibits driving of the driver blade from its top-dead center position toward its bottom-dead center position.

20. The powered fastener driver of claim 15, wherein the controller can determine that the storage chamber pressure is an unusable pressure at which fasteners may not enter the workpiece to a desired depth, and the pattern is indicative of the unusable pressure.
